(19) United States
(12) Patent Application Publication
(10) Pub. No.: US 2017/0301000 A1
(43) Pub. Date: Oct. 19, 2017

(54) SYSTEMS AND METHODS THAT PROVIDE CUSTOMERS WITH ACCESS TO RENDERED RETAIL ENVIRONMENTS

(71) Applicant: Wal-Mart Stores, Inc., Bentonville, AR (US)

(72) Inventors: Starla C. Morgan, Bentonville, AR (US); Bruce W. Wilkinson, Rogers, AR (US); Todd D. Mattingly, Bentonville, AR (US)

(21) Appl. No.: 15/487,760

(22) Filed: Apr. 14, 2017

Related U.S. Application Data
(60) Provisional application No. 62/323,026, filed on Apr. 15, 2016.
(60) Provisional application No. 62/348,444, filed on Jun. 10, 2016.
(60) Provisional application No. 62/436,842, filed on Dec. 20, 2016.
(60) Provisional application No. 62/485,045, filed on Apr. 13, 2017.
(60) Provisional application No. 62/356,439, filed on Jun. 29, 2016.

(51) Int. Cl. G06Q 30/06; G06F 17/30

(52) U.S. Cl. CPC G06Q 30/0631; G06F 17/30604

(57) ABSTRACT

In some embodiments, apparatuses and methods provide a remote retail system comprising: a retail service control circuit that executes code to: identify a first customer remotely accessing a first rendered retail environment configured for the first customer; access a set of customer partiality vectors corresponding to the first customer; identify a first set of recommended products each having at least a threshold relationship between corresponding product partiality vectors and one or more of the first customer's partiality vectors; and communicate, to the customer computing system, recommendation content that dictates an organization of displayed representations of products in the first rendered retail environment specific to the first customer and causes graphical representations of the first set of recommended products to be displayed within the first rendered retail environment.

### CROSS-REFERENCE TO RELATED APPLICATION

This application claims the benefit of each of the following U.S. Provisional applications, each of which is incorporated herein by reference in its entirety: 62/323,026 filed Apr. 15, 2016 (Attorney Docket No. 8842-137893-USPR_1235US01); 62/348,444 filed Jun. 10, 2016 (Attorney Docket No. 8842-138849-USPR_3677US01); 62/436,842 filed Dec. 20, 2016 (Attorney Docket No. 8842-140072-USPR_3678US01); 62/485,045, filed Apr. 13, 2017 (Attorney Docket No. 8842-140820-USPR_4211US01); and 62/356,439, filed Jun. 29, 2016 (Attorney Docket No. 8842-138118-USPR_1231US01).

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. Existing preference-based approaches leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

Disclosed herein are embodiments of systems, apparatuses and methods pertaining to systems and methods providing access to rendered retail environments. This description includes drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 illustrates a simplified block diagram of a retail system, in accordance with some embodiments;

FIG. 19 illustrates an exemplary system for use in implementing methods, techniques, devices, apparatuses, systems, servers, sources and providing access to rendered retail environments, in accordance with some embodiments; and

FIG. 20 illustrates a simplified flow diagram of a process of providing a virtual retail shopping environment, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

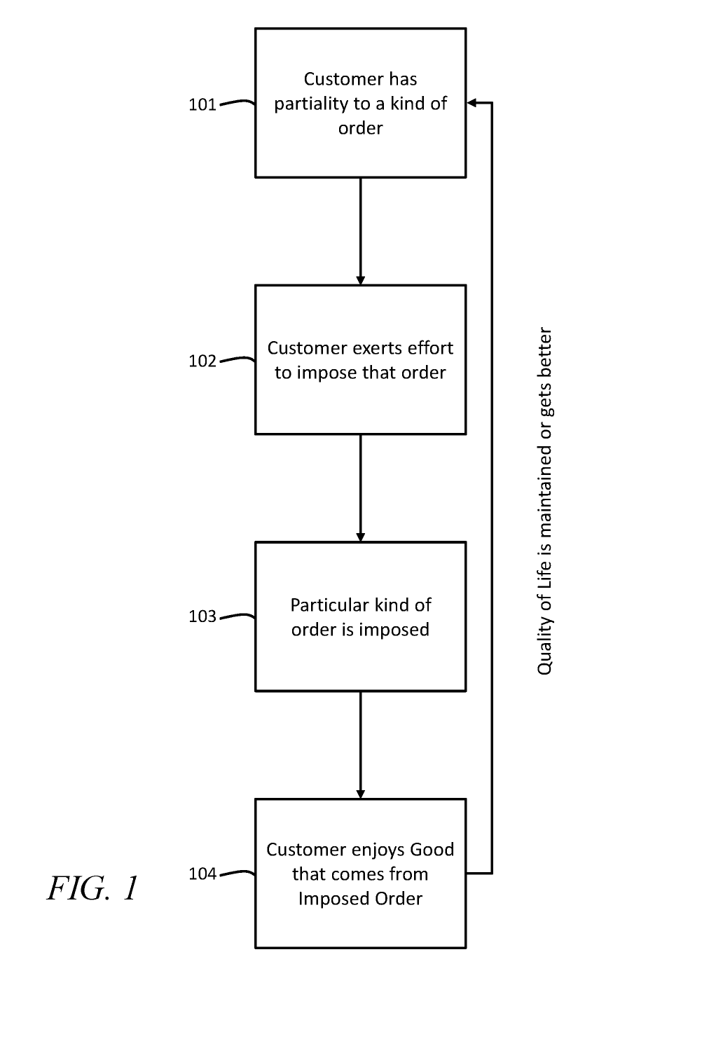

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

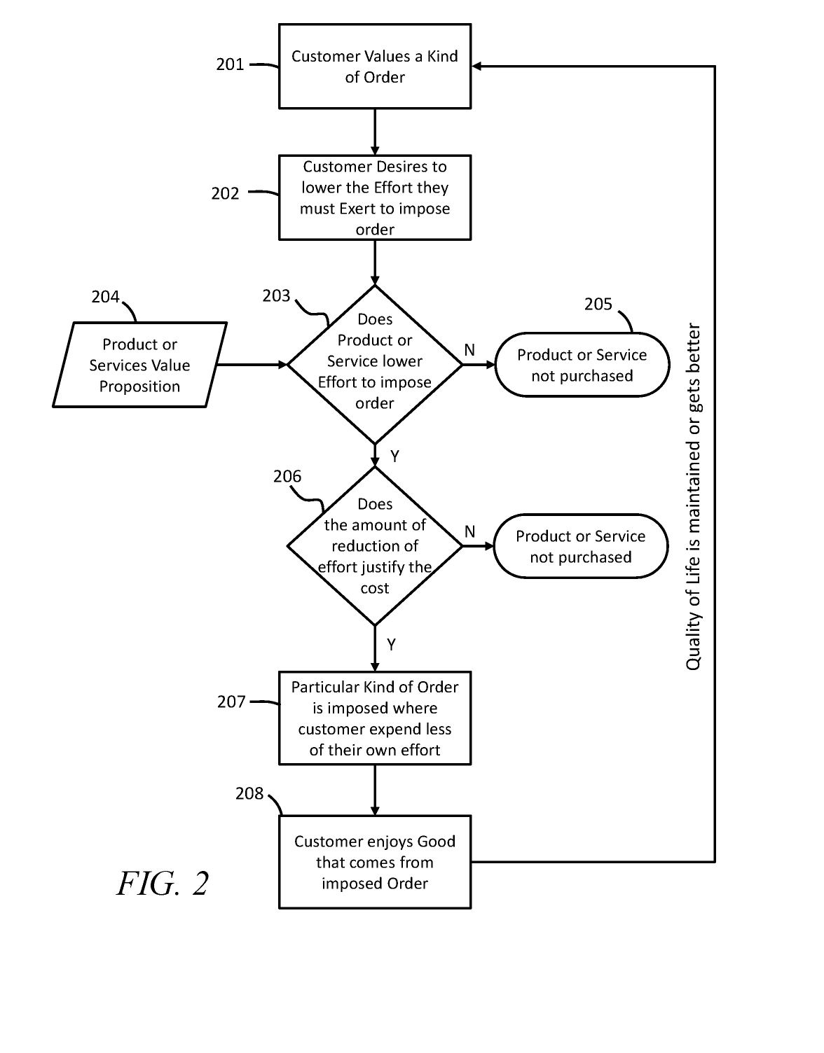

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

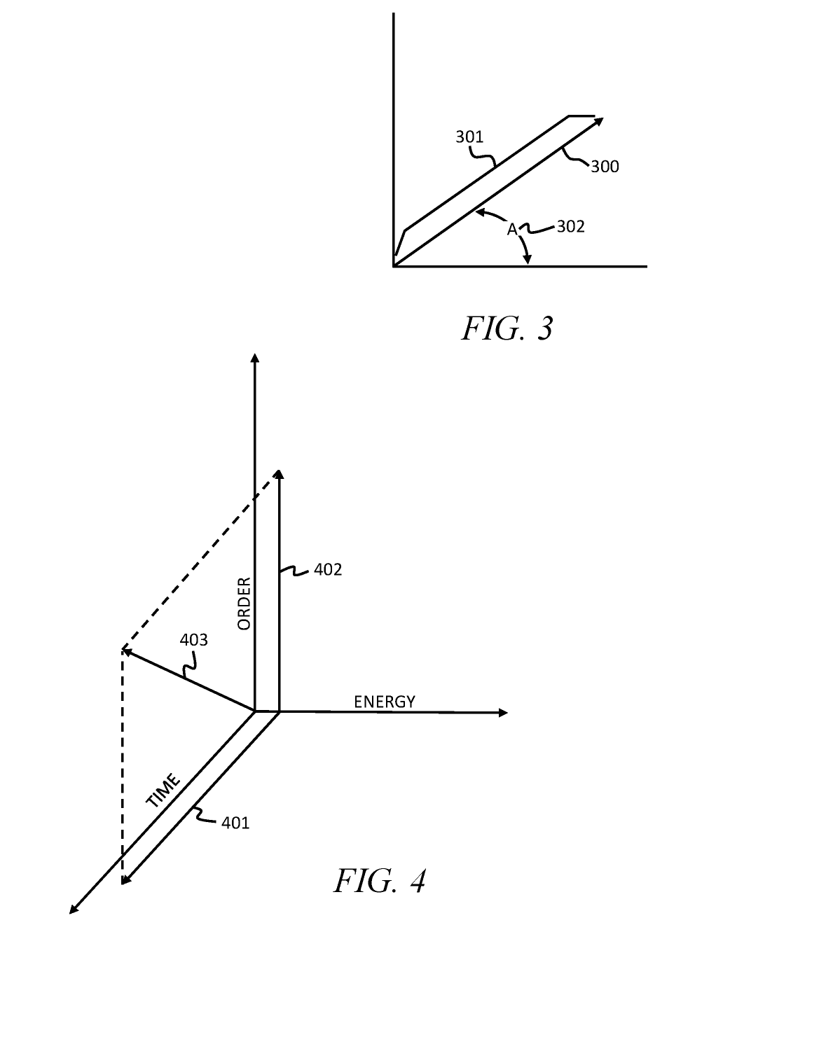

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

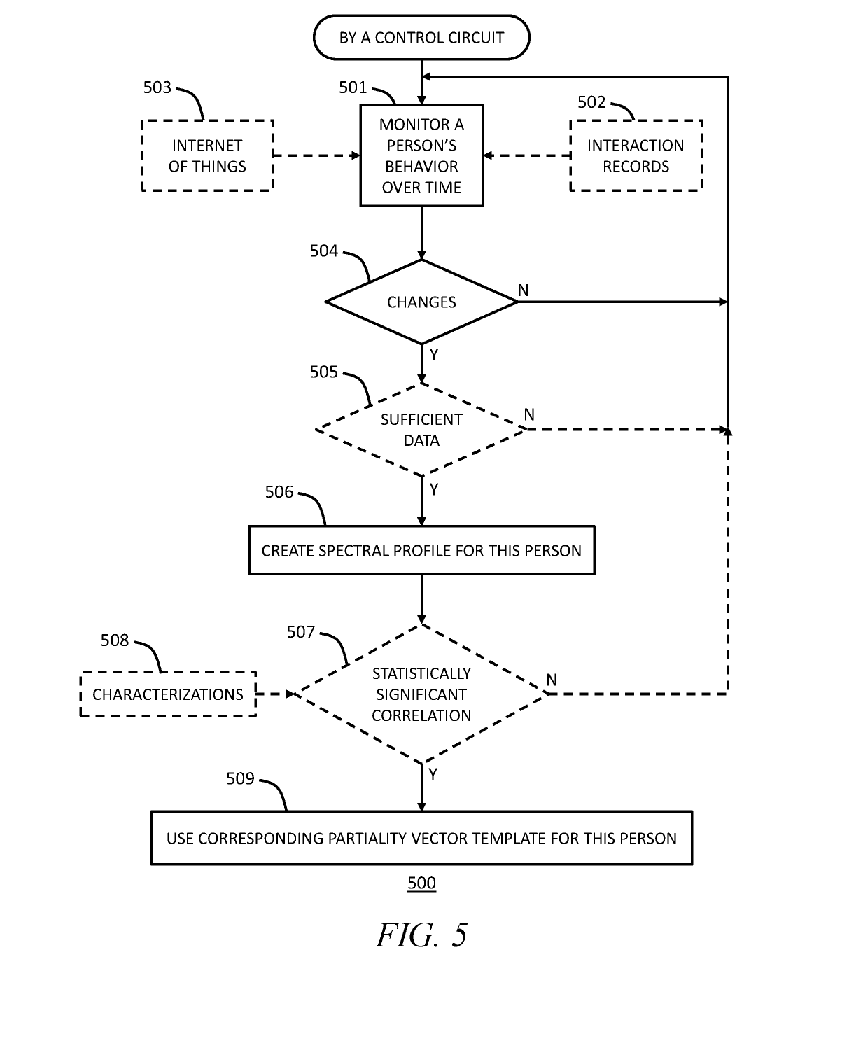

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

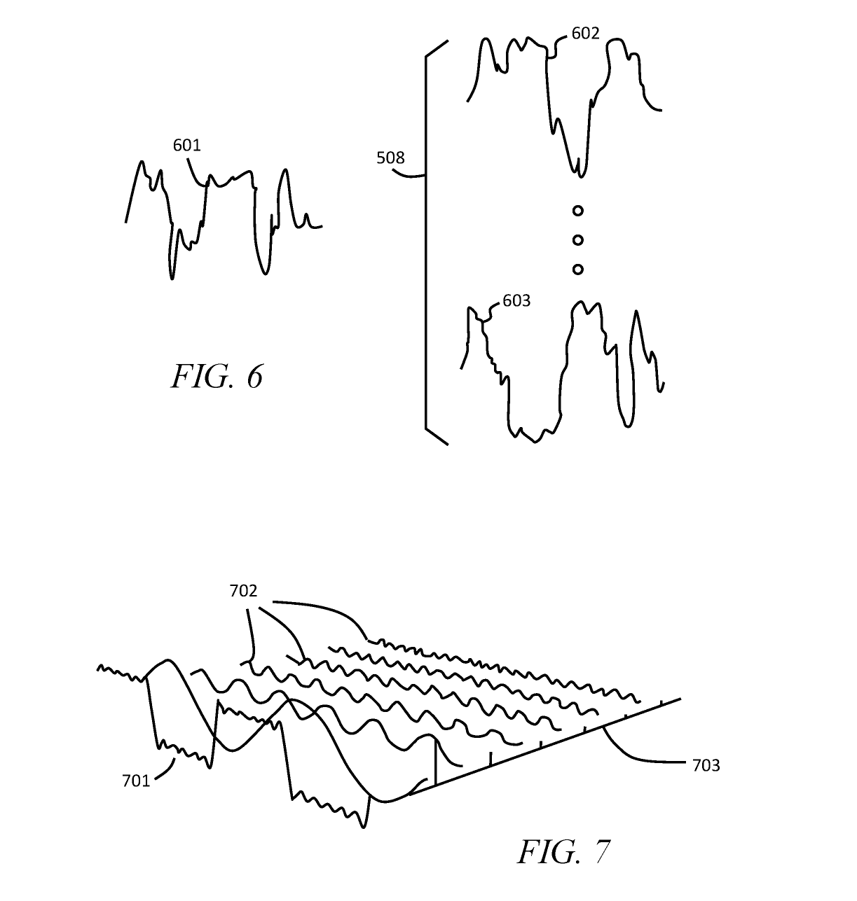

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

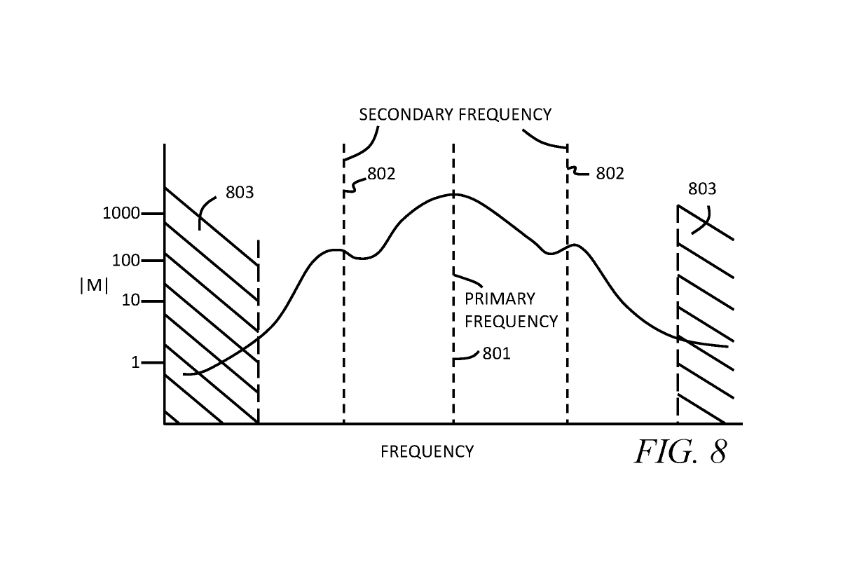

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product).

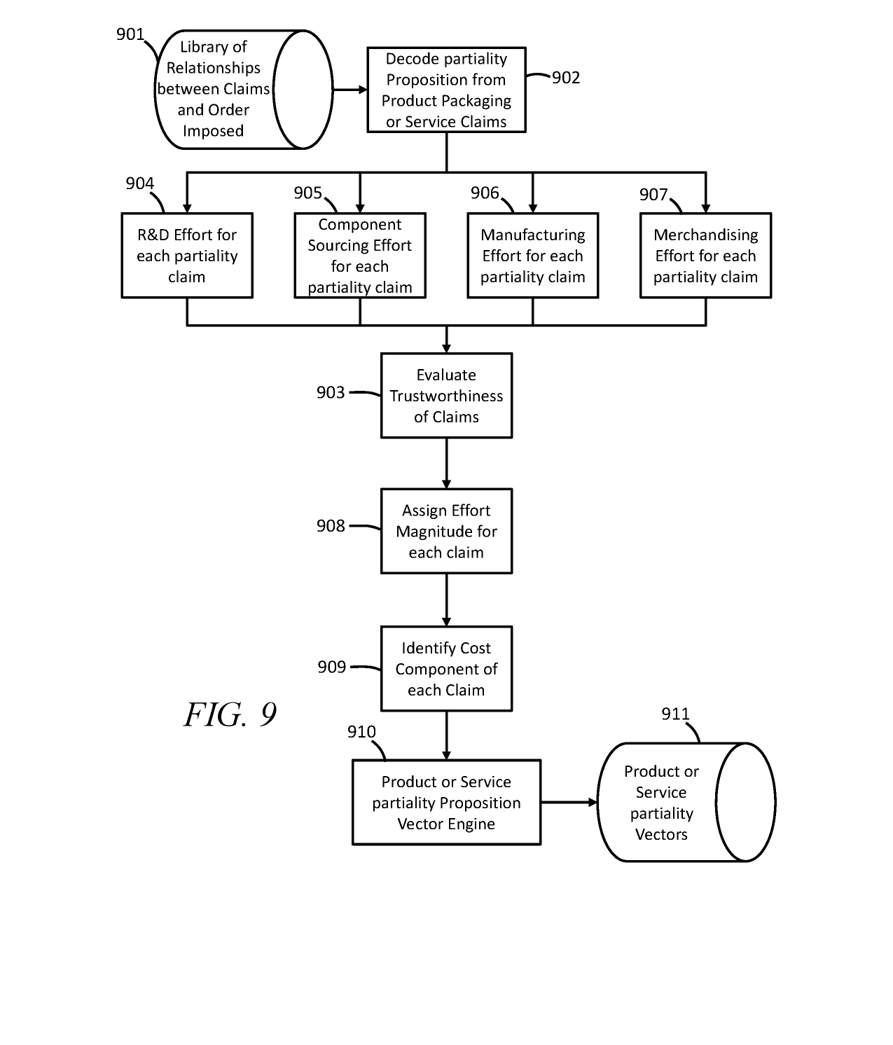

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

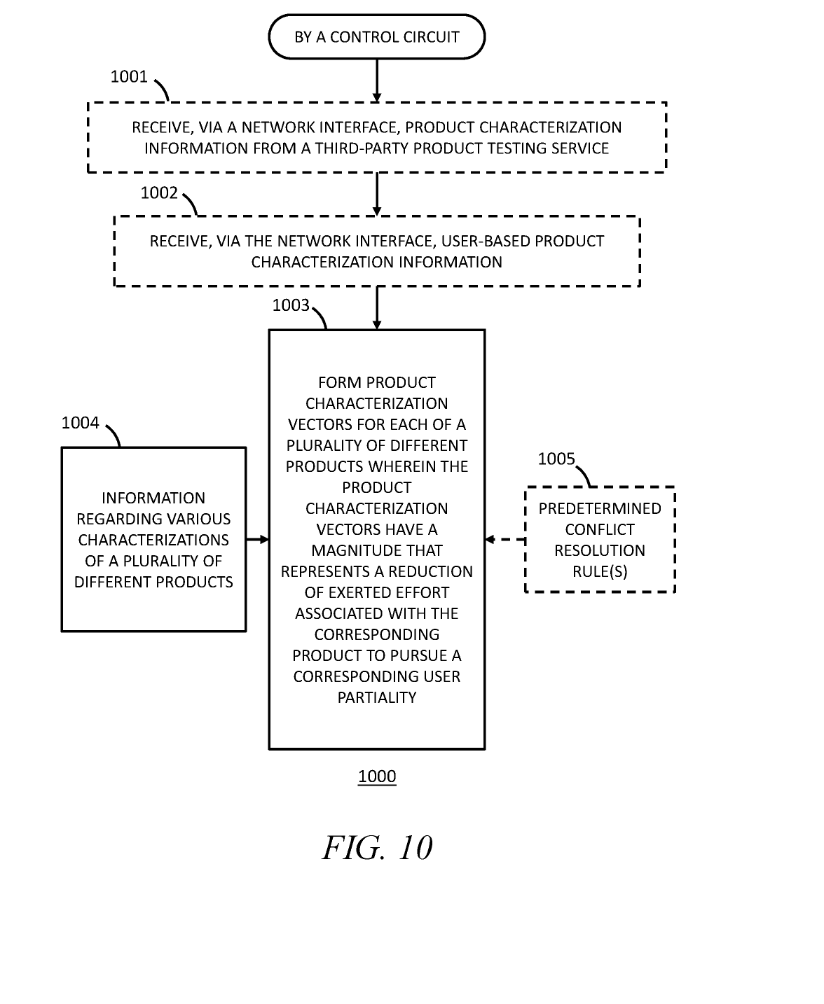

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

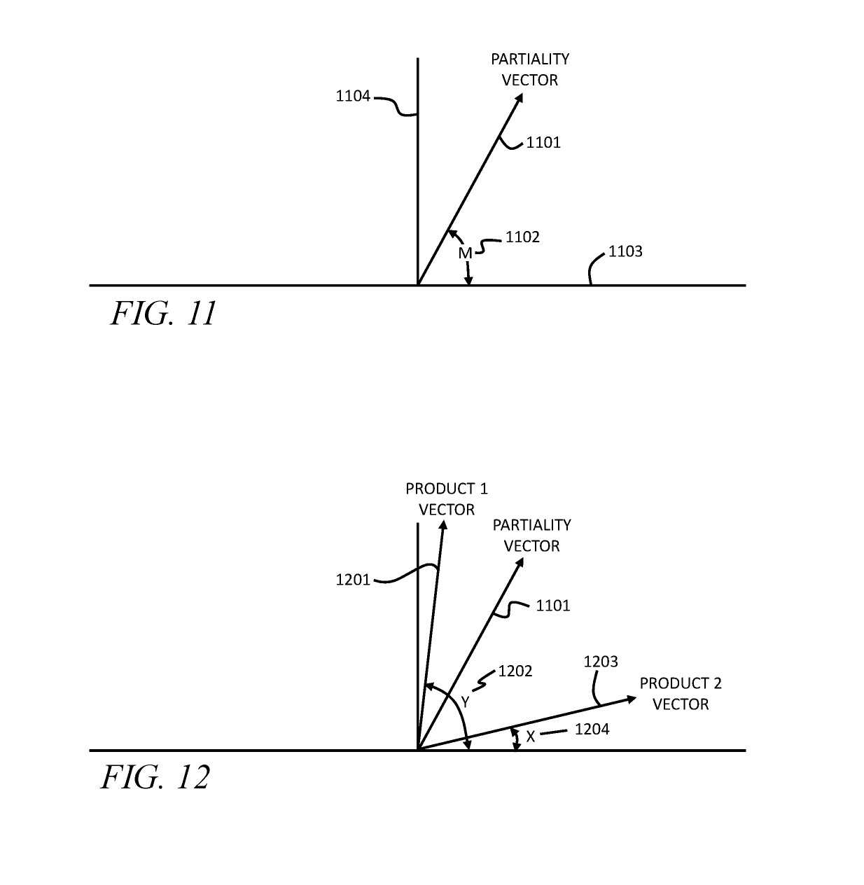

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and Ply represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

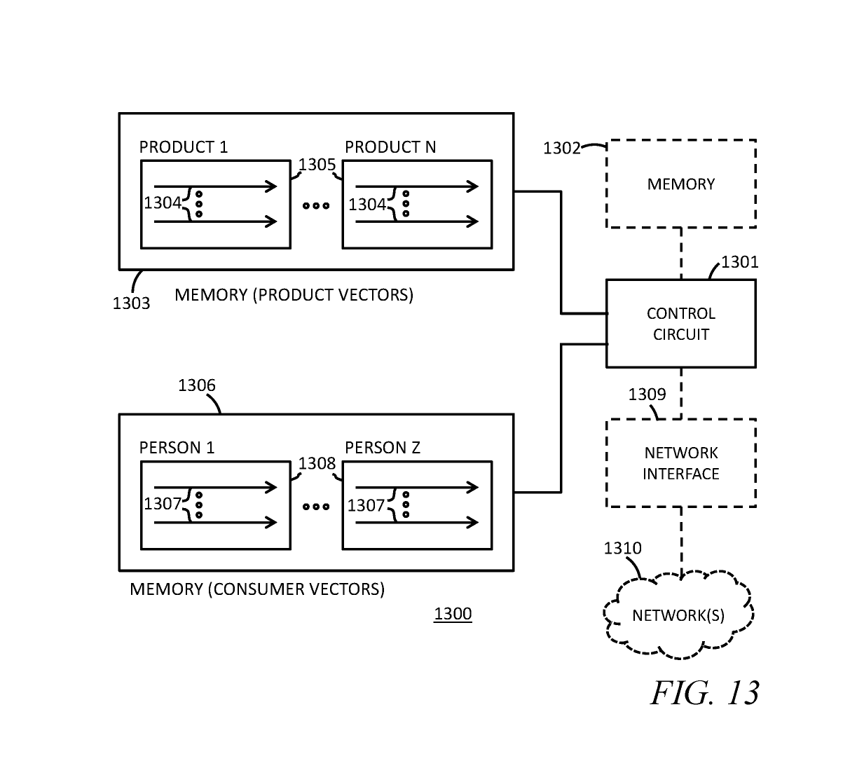

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”). It will be appreciated that the number of persons and products for whom such information is stored can be large. Storing partiality-based information in a vectorized format can greatly ease both digital storage requirements and computational resource requirements. Those skilled in the art will appreciate these improvements to the technical capabilities of both the memory and computer capabilities of such a platform.

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

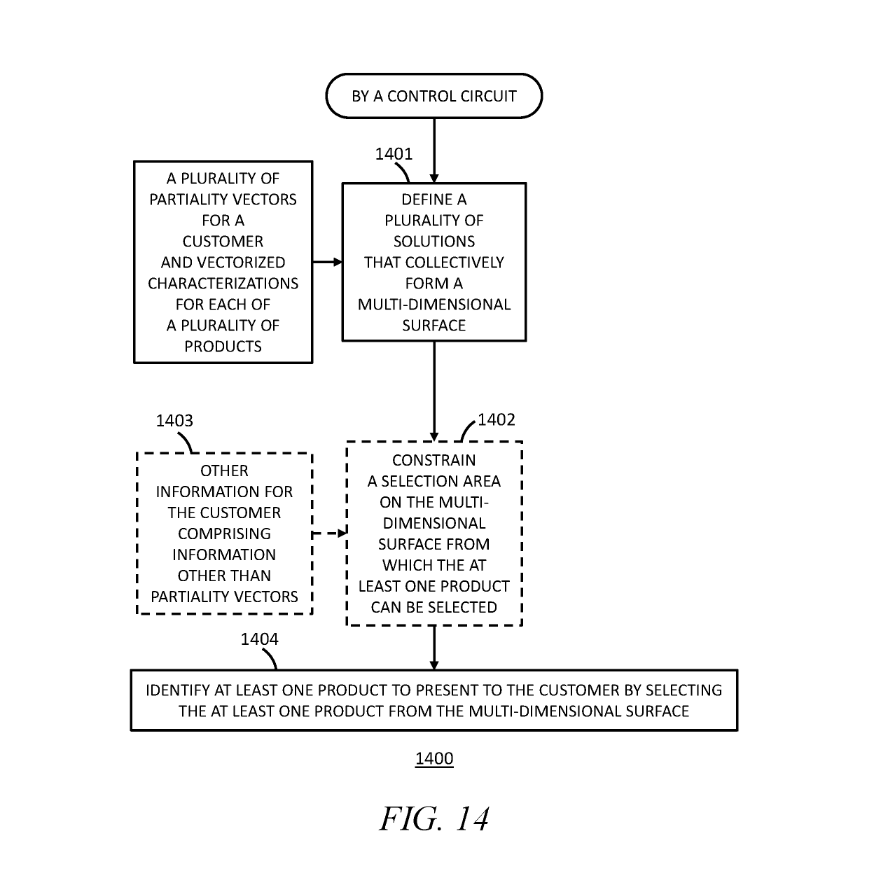

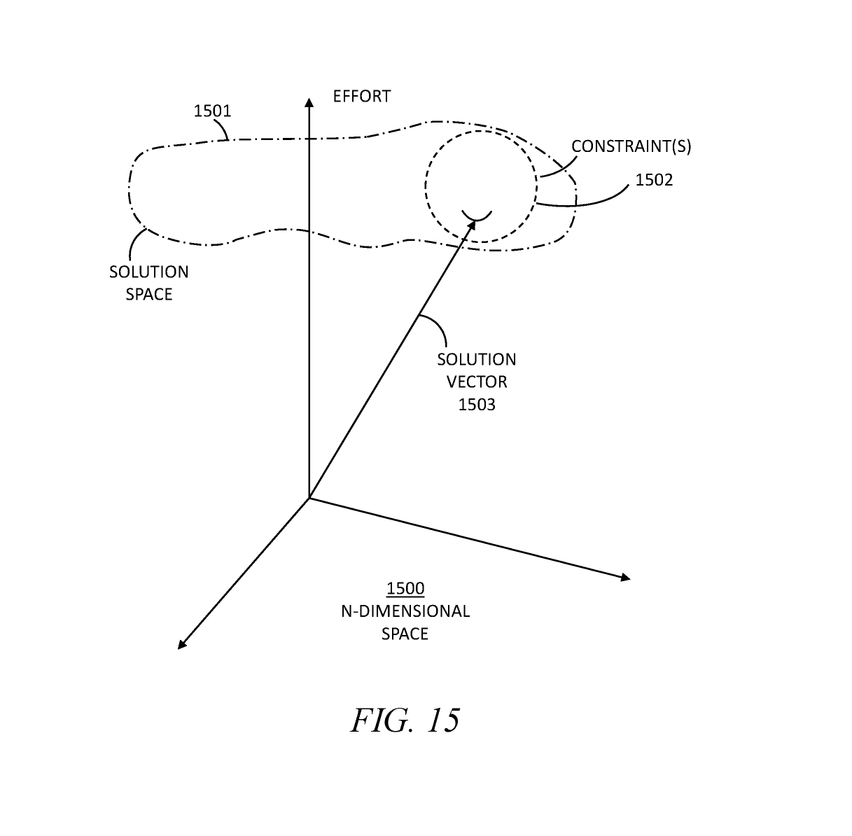

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

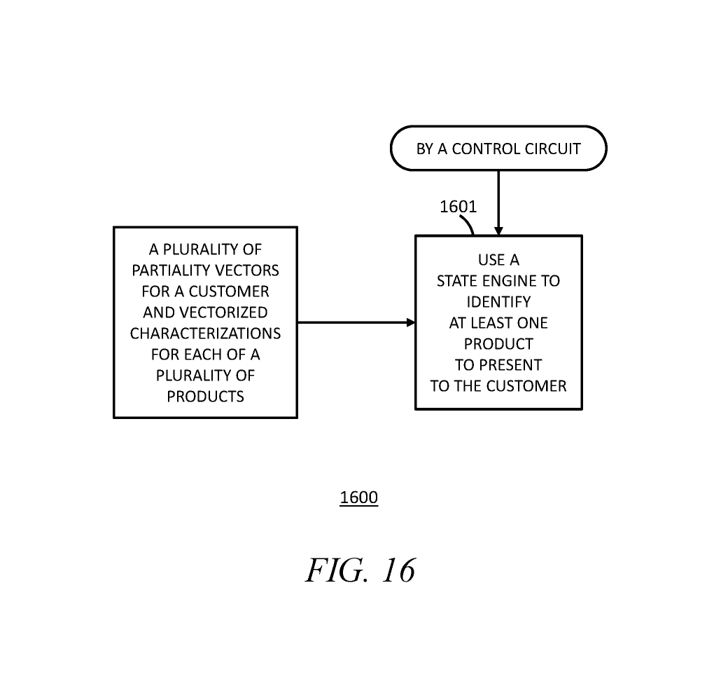

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

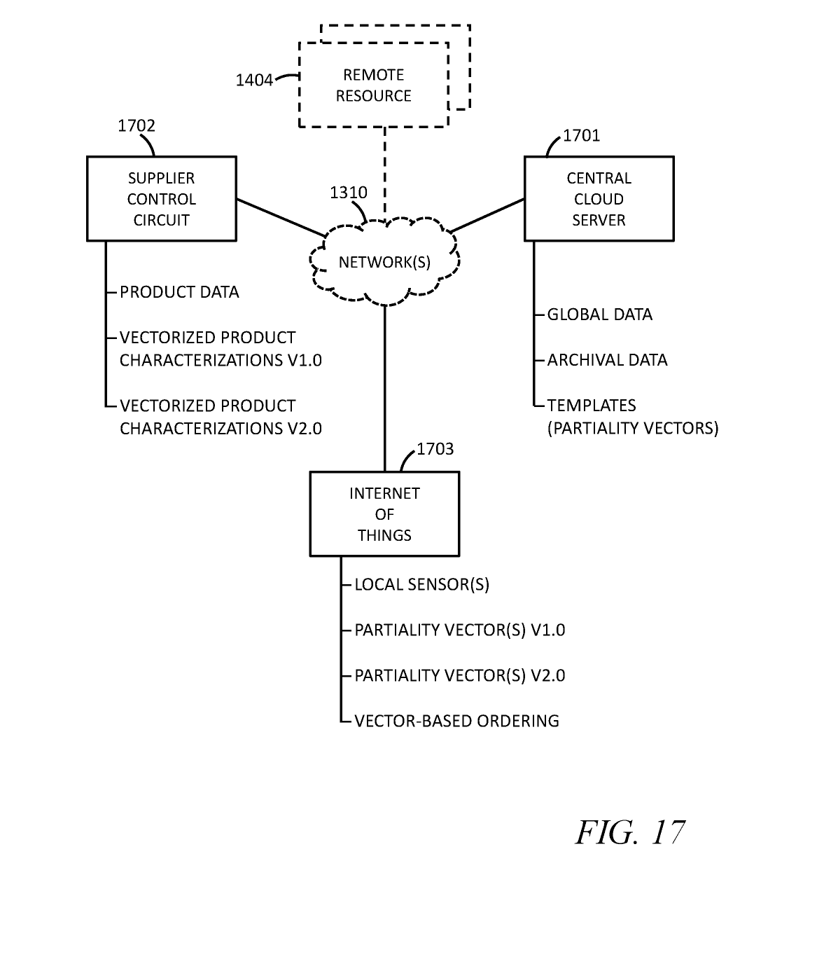

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Pursuant to various embodiments, systems, apparatuses and methods are described herein that provide a remote retail system. The system comprises a retail service control circuit remotely accessible by customers over a distributed computer network and that provides access to computer-graphically rendered retail environments. Customers can be identified that are remotely accessing, through a corresponding customer computing system, a rendered retail environment configured for the corresponding customer. A set of customer partiality vectors are accessed that correspond to the customer. The customer partiality vectors at least in part are directed quantities that each have both a magnitude and a direction, with the direction representing a determined order imposed upon material space-time by a particular partiality and the magnitude represents a determined magnitude of a strength of the belief, by the customer, in a benefit that comes from that imposed order. A set of recommended products can be identified that each have at least a threshold relationship between corresponding product partiality vectors and one or more of the customer's partiality vectors. Recommendation content can be communicated to the customer computing system that dictates an organization of displayed representations of products in the rendered retail environment specific to the customer and causes graphical representations of the first set of recommended products to be displayed within the first rendered retail environment.

Some embodiments utilize the partiality vectors in improving a customer shopping experience. This can be extended to shopping within a retail facility to on-line shopping and beyond. Further, some embodiments utilize the partiality vectors to provide a computer-graphically rendered retail environments that are configured specific to each customers.

FIG. 18 illustrates a simplified block diagram of a retail system 1800, in accordance with some embodiments. The retail system 1800 includes a remotely accessible retail service system 1802 that is communicatively coupled with one or more inventory systems 1804 and one or more databases 1806 over one or more distributed computer and/or communication networks 1310. The databases 1806 can include one or more product databases storing at least product partiality vectors 1304, and one or more customer databases that include customer partiality vectors 1307. The system 1800 further enables multiple customer computing systems that are geographically distributed to access and communicate with at least the retail service system 1802 to receive information and/or instructions used to generate graphically rendered retail environments in accordance with some embodiments.

In some embodiments, the retail system 1800 may include one or more purchasing systems 1812 that enable a retail entity to receive payment from a customer purchasing one or more products through the retail system 1800, a customer profile system 1814 that receives, generates, maintains and updates customer information associated with multiple different customers, including customer partiality vector information. In some embodiments, the customer profiles generated and/or maintained by the customer profile system may be stored in memory 1306 as part of a customer database and/or customer profile database. The system may include a product profile system 1816 that receives, generates, maintains and updates product information and/or profiles associated with multiple different products, including product partiality vector information. The product information generated and/or maintained by the product profile system 1816 may, in some implementations, be stored in memory 1303 as part of a product database and/or product profile database. In some embodiments, the system 1800 includes a delivery control system 1818 that can provide instructions regarding the delivery of products ordered by customers.

The retail service system 1802 enables customers to remotely access the product information through the customers' computing systems 1808. The customers' computing systems can be substantially any relevant system that allows the customer to remotely access the retail service system, such as but not limited to computers, laptops, smart phones, tablets, network enabled televisions, and other such components. The retail service system in part uses customer partiality vectors and their association with one or more product partiality vectors of products to dictate how and what is graphically displayed to the customer when accessing product information displayed as a computer-graphically rendered retail environment through which the customer can virtually navigate in shopping for products.

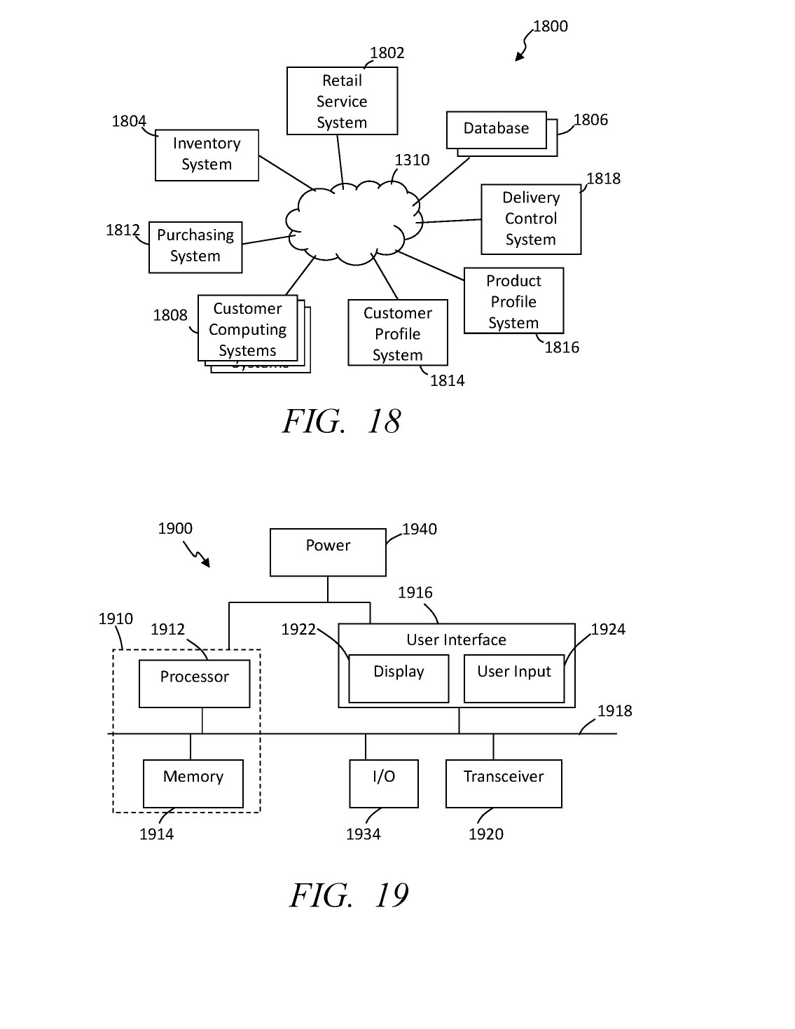

Further, the circuits, circuitry, systems, devices, processes, methods, techniques, functionality, services, servers, sources and the like described herein may be utilized, implemented and/or run on many different types of devices and/or systems. FIG. 19 illustrates an exemplary system 1900 that may be used for implementing any of the components, circuits, circuitry, systems, functionality, apparatuses, processes, or devices of the apparatus 1300 of FIG. 13, the system 1800 of FIG. 18, and/or other above or below mentioned systems or devices, or parts of such circuits, circuitry, functionality, systems, apparatuses, processes, or devices. For example, the system 1900 may be used to implement some or all of the retail service systems 1802, the inventory system 1804, the databases 1806, the customer computing systems 1808, purchasing system 1812, customer profile system 1814, product profile system 1816, delivery control system 1818, and/or other such components, circuitry, functionality and/or devices. However, the use of the system 1900 or any portion thereof is certainly not required.

By way of example, the system 1900 may comprise a control circuit or processor module 1912, memory 1914, and one or more communication links, paths, buses or the like 1918. Some embodiments may include one or more user interfaces 1916, and/or one or more internal and/or external power sources or supplies 1940. The control circuit 1912 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1912 can be part of control circuitry and/or a control system 1910, which may be implemented through one or more processors with access to one or more memory 1914 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1900 may be used to implement one or more of the above or below, or parts of, components, circuits, systems, processes and the like. For example, the system may implement the retail service system 1802 with the control circuit being a retail service control circuit, the inventory system 1804 with an inventory system control circuit, a customer computing system with the control circuit being a computing system control circuit, or other components.

The user interface 1916 can allow a user to interact with the system 1900 and receive information through the system. In some instances, the user interface 1916 includes a display 1922 and/or one or more user inputs 1924, such as a buttons, touch screen, track ball, keyboard, mouse, etc., which can be part of or wired or wirelessly coupled with the system 1900. Typically, the system 1900 further includes one or more communication interfaces, ports, transceivers 1920 and the like allowing the system 1900 to communicate over a communication bus, a distributed computer and/or communication network 1310 (e.g., a local area network (LAN), the Internet, wide area network (WAN), etc.), communication link 1918, other networks or communication channels with other devices and/or other such communications or combination of two or more of such communication methods. Further the transceiver 1920 can be configured for wired, wireless, optical, fiber optical cable, satellite, or other such communication configurations or combinations of two or more of such communications. Some embodiments include one or more input/output (I/O) ports 1934 that allow one or more devices to couple with the system 1900. The I/O ports can be substantially any relevant port or combinations of ports, such as but not limited to USB, Ethernet, or other such ports.

The system 1900 comprises an example of a control and/or processor-based system with the control circuit 1912. Again, the control circuit 1912 can be implemented through one or more processors, controllers, central processing units, logic, software and the like. Further, in some implementations the control circuit 1912 may provide multiprocessor functionality.

The memory 1914, which can be accessed by the control circuit 1912, typically includes one or more processor readable and/or computer readable media accessed by at least the control circuit 1912, and can include volatile and/or nonvolatile media, such as RAM, ROM, EEPROM, flash memory and/or other memory technology. Further, the memory 1914 is shown as internal to the control system 1910; however, the memory 1914 can be internal, external or a combination of internal and external memory. Similarly, some or all of the memory 1914 can be internal, external or a combination of internal and external memory of the control circuit 1912. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 1310. The memory 1914 can store code, software, executables, scripts, data, content, lists, programming, programs, log or history data, user information, customer information, product information, and the like. While FIG. 19 illustrates the various components being coupled together via a bus, it is understood that the various components may actually be coupled to the control circuit and/or one or more other components directly.

Some embodiments include the I/O interface 1934 that allows wired and/or wireless communication coupling to external components. Typically, the I/O interface provides wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The retail service control circuit is remotely accessible by customers over the distributed computer network 1310 and provides access to computer-graphically rendered retail environments. The system can identify customers remotely accessing, through their customer computing systems, the retail service system and rendered retail environments. In some embodiments, the retail service system provides each customer with access to a rendered retail environment that is specific to each customer.

Further, the retail service system accesses, for each customer accessing the retail service system, a set of customer partiality vectors corresponding to the customer. As described above, the customer partiality vectors are directed quantities that each have both a magnitude and a direction. The direction represents a determined order imposed upon material space-time by a particular partiality, and the magnitude represents a determined magnitude of a strength of the belief, by the customer, in a benefit that comes from that imposed order. Further, those products and/or services that are aligned with a customer's partiality vector are those products and/or services that the customer perceives to provide a significant or the most benefit to her/himself. The retail service system can further access the product partiality vectors to evaluate products relative to the customer's partiality vectors. Using the customer partiality vectors, a first set of recommended products can be identified with each recommended product having at least one threshold relationship between corresponding product partiality vectors and one or more of the customer's partiality vectors. In some embodiments, the use of the partiality vectors attempts to minimize stress in customers' lives. Often stress is a function of time that is inefficiently used and/or wasted, wasted physical effort, wasted mental thought, doing things that are in opposition with a customer's partialities, etc. These elements of stress include objective data (e.g., purchase history, weather, standard time needed to prepare a meal, etc.) and subjective data (e.g., looking at social media and other public behavior to determine a consumer profile and/or partiality vectors. By identifying products that have threshold alignment with customers' partiality vectors, the system can identify solutions that may minimize customers' stress, and satisfy the needs of the customers.

The relationships between customers' partiality vectors and product partiality vectors can be based on the directional aspect, the magnitude aspect, or some combination of the directional and magnitude aspects. In some instances for example, the correlation should satisfy a threshold directional correlation or alignment and a magnitude threshold. The thresholds may vary between customers and/or products. Further, the thresholds may be sliding thresholds such that when a greater correlation between one of the directional aspect or the magnitude aspect is identified, a lower threshold for the other of the magnitude aspect or directional aspect has to be met to consider the product to be sufficiently consistent with that customer and/or the customer's partiality vectors.

Based the identification of products that correspond with the customer's partiality vectors the system can customize the rendered retail environment. The customization can include highlighting one or more of those products, causing the strategic positioning of a virtual graphical representation of one or more of those products within the rendered virtual retail environment, causing additional information to be displayed relative to one or more of those products, and other such modifications. Further, the retail service system 1802 may customize the rendered retail environment to define the organization of representations of products, including at least their virtual placement within the rendered retail environment. Again, those products and/or services that align with a customer's partiality vector are those products and/or services that are determined to be perceived by a customer as provide a significant benefit or the most benefit to that customer. Accordingly, some embodiments arrange recommended products and/or non-recommended products within the rendered retail environment, which can include organizing at least some products from those that are perceived to provide a greater beneficial to those that are perceived to be less beneficial.

In some embodiments, the retail service system communicates, to a customer computing system, recommendation content that dictates an organization of displayed representations of products in the rendered retail environment specific to a customer and causes graphical representations of a set of recommended products to be displayed within the rendered retail environment. As described above, the rendered virtual retail environment may be displayed through a customer's computing device, by accessing a web site, by implementing application software (APP) that receives content, information, instructions and/or code to cause the rendering of the retail environment, or other such software implemented on a computing device to allow the rendering of the retail environment. Accordingly, the retail service system can cause web pages to be generated and distributed to the customer's computing device, cause content, information, instructions and/or code to be communicated to a computing device, other such communications, or a combination of two or more of such communications. The recommendation content can include the code, graphics information, organization information and the like relative to at least the display within the rendered retail environment of representations of products that have partiality vectors that align with the customer's partiality vectors.

Some embodiments cause marketing information to be displayed that corresponds to one or more products, and often correspond to products that have a threshold relationship with the customer's partiality vectors. One or more products may be identified, based on and/or from product information for one or more recommended products, that have at least one product partiality vector that has the threshold relationship with at least one of the first customer's partiality vectors. Marketing information consistent with product partiality vector(s) that has/have the relationship with the customer's partiality vector(s) can be identified and accessed. In some implementations, the marketing information may be included in and/or referenced in a product profile, identified in a database and associated with that customer and/or that partiality vector, or the like. Instructions, content and/or information can be communicated to the customer computing device to cause the marketing information representative of at least the corresponding product partiality vector to be displayed in association with the displayed graphical representation of the recommended product.

As such, information that is more likely to be considered important to the customer and/or may more likely influence the customer in making a purchasing decision can be provided to the customer to help the customer identify products that are consistent with the customer's partiality vectors. For example, information about a product being developed without animal testing may be displayed in relation to a product when a customer has a strong partiality vector corresponding to animal rights and/or opposition to animal cruelty. The display of the information can simplify shopping for the customer because the customer is more easily able to identify products that customer likely wants to purchase. Further, the information may provide the customer the feeling that there is an emotional relationship with the retailer because the customer may feel that the retailer understands the customer and appreciates the customer's partialities and/or values. Some embodiments may further provide customized incentives to the customer based on an alignment of the incentive with the customer's partiality vectors and/or a prediction that a particular product, which has been identified to have product partiality vectors that align within one or more thresholds of the customer's partiality vectors, in attempt to get the customer to make a purchase. Similarly, the system may incentive the customer to share product information with one or more other potential customers.

The system, in some embodiments, can use subsequent purchases, products viewed and/or considered by the customer in the rendered retail environment, products disregarded and/or ignored by the customer, and other such actions made by the customer to evaluate the impact and/or likelihood that the displayed product information had on the customer's purchases, and when relevant make adjustments to the future display of product information. Further, the actions taken by the customer, the product information, the product organization, and the like can be used as a feedback to the system to additionally or alternatively make adjustments to the directional aspect and/or magnitude aspect of one or more of the customer's partiality vectors and/or product partiality vectors.

In some embodiments, graphics, information, instructions and/or code are communicated to the computing device to cause the marketing information to be displayed as an emphasized characteristic of the one or more recommended products. For example, the marketing information may be highlighted on the product, temporarily displayed over adjacent displayed products, displayed in a separate location with a graphical line or other indication to direct attention to the separate location, other such methods or combination of two or more of such methods.

Further, the retail service system typically organizes displayed products within the rendered retail environment. In some embodiments, this organization is based in part on the relationships and/or alignments between customer partiality vectors and product partiality vectors. In some embodiments, one or more products can be identified, based on historic purchase history of a customer, that have not previously been purchased by the customer and that each have one or more product partiality vectors that have the threshold relationship with at least one of the customer's partiality vectors. Recommendation content can be communicated that cause a graphical representation of one or more of these products to be strategically displayed to draw the customer's attention to the one or more products.

The organization of the rendered retail environment and the organization of the displayed products within the rendered retail environment can be based in part on a prioritization of products relative to at least the customer's partiality vectors. Some embodiments determine product prioritization, at least in part, as a function of a level of correlation between the product partiality vectors of the multiple recommended products and a customer's set of partiality vectors. For example, in some embodiments, define greater priority to products that have a greater correlation with the customer's partiality vectors. Further, the priority is typically different for each customer for which partiality vectors are established. As such, different customers have different prioritized products, and product prioritization information defining a priority, a level of priority, a prioritization class, other such prioritization, or combination of two or more of such prioritization, can be generated based on the correlation between products' partiality vectors and a customer's partiality vectors.

Product prioritization information may further prioritize multiple recommended products of a set of recommended products. Some or all of the product prioritization information can be used in generating the recommendation content so that when applied by the customer's computing device the recommendation content causes the graphical representations of multiple recommended products of the set of recommended products to be displayed in virtual locations within the rendered retail environment and/or in an order at least based on the prioritization of the multiple recommended products. The prioritization may further take into consideration customer's historic purchases, preferences and other aspects. Some embodiments identify, based on customer information (e.g., from the customer profile database, which may be part of the customer database 1306), product preferences corresponding to one or more of the multiple recommended products. The product preferences may, at least in part, correspond to a customer's historic tendency of purchasing one or more products over one or more secondary similar products that the customer has purchased. In some implementations, the product prioritization information can be determined, at least in part, as a function of the product preferences and the level of correlation between the product partiality vectors of multiple recommended products and the customer's set of partiality vectors.

Some embodiments further utilize customer's previous historic purchases and/or a purchase history in customizing the rendered retail environment. For example, a customer's historic purchases can be used to identify customization parameters specific to the customer and correlated to purchased products. The customization parameters can be substantially any relevant parameter that defines aspects or features of products tended to be purchased by a customer. For example, the customization parameters may include one or more sizes of products (e.g., size(s) of pants that are purchased, size(s) of shoes that are purchased), colors that a customer tends to purchase, quantities the customer tends to purchase when products are available in different quantities (e.g., small quantities versus family pack size), and other such customization parameters. The customization parameters may be determined as an average, based on a percentage of purchases, recent changes in purchase patterns, other such aspects or combinations of such aspects. Further, some embodiments apply weightings to some purchases in determining a customization. For example, more recent purchases may be given greater weight than older purchases, consistent purchases may be given greater weight over individual or small number purchases, and other such weightings.

The retail service system can use the customization parameters to determine and/or modify graphical characteristics of one or more of the set of recommended products and/or other products to be consistent with customization parameters and with available actual products. In some embodiments, the retail service system communicates with the inventory system 1804 to determine whether a recommended product (or other product) is available with characteristics that are consistent with the customization parameters. For example, the retail service system may identify a pair of shoes that the system wants to recommend, and can access the inventory system and/or an inventory database to determine whether the recommended shoes are available in the size the customer typically purchases and/or in what colors are available. When the product is not available in a particular size the retail service system may not include the product as a recommended product or may cause a notification to be displayed in association with the displayed recommended product in the rendered retail environment that the customer would have to wait for shipment. Similarly, the retail service system may modify how the recommended product is rendered based on the available inventory. For example, when the available inventory of a product has a color of red or blue, but colors green and yellow are not available, and the customer's customization parameters indicate the customer does not typically purchase the product in blue, the retail service system may cause the rendered recommended product to be displayed in red and not display the product in blue, green or yellow. As such, in some embodiments the retail service system in communicating the recommendation content further causes the graphical representations of the one or more of the set of recommended products to be displayed in accordance with modified graphical characteristics.

In some embodiments, the retail service system determines a virtual location within the rendered retail environment in which the customer is currently interested. For example, the system may define a mapping of the rendered retail environment with different products being associated with different areas of the rendered retail environment. The customer can control the display and can virtually navigate through the retail environment. The retail service system can track the customer's virtual location within the mapped retail environment. The system can identify one or more recommended products of the set of recommended products based on a relationship of the set of recommended products relative to the virtual location and based on the relationship between the products' partiality vectors and the customer's partiality vectors. For example, the retail service system and/or the customer's computing system may identify a customer's virtual location within the retail environment. Based on this virtual location the system can identify, based on the organization of products within the rendered retail environment, which products are associated or organized in accordance with that location, including one or more recommended products associated with that virtual location. The retail service system can then cause those recommended products that are further associated or organized in relation to that virtual location to be rendered. Further, in some instances, because of the products are recommended products, the retail service system may modify the organization of products to make those recommended products associated with the virtual location to be moved within the rendered retail environment to appear closer to the customer's view and/or be placed in an area of the display to be more likely seen (e.g., based on evaluation of customer's viewing and/or purchases through rendered retail environments).

As described above, some embodiments determine product prioritization information prioritizing multiple recommended products of a set of recommended products as a function of a level of correlation between the product partiality vectors of the multiple recommended products and the customer's set of partiality vectors. The retail service system may determine a retail environment organization data dictating an organization of the rendered retail environment based on the product prioritization information. The retail environment organization data can be communicated to the customer computing system to cause the graphical representations of the rendered retail environment to be displayed in accordance with the organization of the rendered retail environment.

In some embodiments, the retail service system 1802 accesses the databases 1806 to obtain the customer partiality vectors and product partiality vectors. The databases may be maintained by one or more retail entities, or maintained by a third party and accessible to the retail service system. The databases, in some applications, optimize the data storage and/or association between various partiality vectors. The databases may include one or more tables that increase flexibility, provide faster search times, and smaller memory requirements. For example, some embodiments the databases comprise series of interdependent cells, with a first set of cells associated with or defining a specific customer with a second set of customer partialities vectors that associate specific customers to relevant partiality vectors with magnitudes for each of the relevant partiality vectors specified within the cell associated between the specific customer and the relevant partiality vectors. In some embodiments, the same database further includes a set of cells associated with or defining a specific product that similarly cross reference the partiality vectors with magnitudes for each of the relevant partiality vectors specified within the cell associated between the specific product and the relevant partiality vectors. As such, cells are interdepending while reducing storage space, and speeding access to the relationships between customers, products and partiality vectors. In other embodiments, a separate product database is maintained with the cells defining the association between the specific products and the product partiality vectors. The retail service system in evaluating products relative to customers can implement an optimized correlation analysis between the customer partiality database and the product partiality database to identify one of a correlation between one or more defined customer partiality vectors for a customer, and product partiality vectors for one or more products, and to further identify a threshold correlation between one of the directional aspect and the magnitude aspect of the customer's partiality vectors and the correlated one or more products. Further, in some applications, the database organization reduces memory by having customer partialities and product partialities reference the same direction and magnitude cells when they are the same.

The product partiality vectors may be provided and/or defined by a product manufacturer, distributor, supplier or other third party service. Further, in some applications, the retail service system 1800 may learn over time product partiality vectors. For example, the retail service system may identify over time customers that purchase a particular product. Based on a commonality of one or more customer partiality vectors between customers purchasing the particular product, the retail service system may associate one or more product partiality vectors consistent with one or more of the common one or more customer partiality vectors. In some implementations, the retail service system may further receive input from one or more customers and/or workers identifying that a product should be associated with a particular product partiality vector. The retail service system may further consider the customer or worker submitting the request, and provide different levels of authority to different customers and workers to identify potential product partiality vectors.

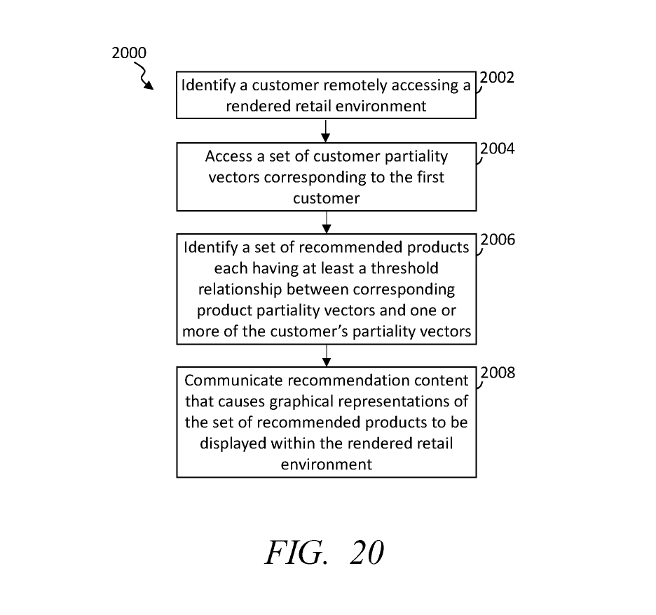

FIG. 20 illustrates a simplified flow diagram of a process 2000 of providing a virtual retail shopping environment, in accordance with some embodiments. In step 2002, a customer is identified that is remotely accessing and/or requesting access to, through a customer computing system, a rendered retail environment configured for the customer. In step 2004, a set of customer partiality vectors are accessed that correspond to the customer. As described above, the customer partiality vectors are directed quantities that each have both a magnitude and a direction, with the direction representing a determined order imposed upon material space-time by a particular partiality and the magnitude represents a determined magnitude of a strength of the belief, by the customer, in a benefit that comes from that imposed order.

In step 2006, a set of recommended products are identified that each have at least a threshold relationship between corresponding product partiality vectors and one or more of the customer's partiality vectors. In step 2008, recommendation content is communicated to the customer computing system that causes graphical representations of the set of recommended products to be displayed within the rendered retail environment. In some embodiments, the recommendation content at least in part dictates an organization of displayed representations of products in the rendered retail environment specific to the customer.

Some embodiments identify, from product information for a recommended product, a product partiality vector that has the threshold relationship with at least one of the first customer's partiality vectors. Marketing information representative of the product partiality vector can be caused to be displayed in association with the displayed graphical representation of the recommended product. In some instances, one or more databases of marketing information may be maintained. In other instances, the marketing information is maintained with the product profile database. Further, in some applications the product partiality vector database may include a link to, reference to and/or otherwise identify one or more marketing information that correspond to one or more of the product partiality vectors. The marketing information may be provided by a product manufacturer, a supplier, a third party or other such sources (e.g., marketing agency). Similarly, the product manufacturer, supplier or other source may specify how and/or request how the marketing information is to be displayed (e.g., positioning relative to the displayed product, coloring, intensity, size, etc.), and/or limitations on where, when and how the marketing information is to be displayed. The marketing information may be displayed as an emphasized characteristic of the one or more recommended products. For example, the marketing information may emphasize a characteristic that is consistent with one or more of the customer's partiality vectors. In one non-limiting example, marketing information may include text and/or a symbol emphasizing a product is made without animal testing.

In some embodiments, the retail service system circuit identifies, based on a purchase history of a customer, one or more products that have not previously been purchased by the customer (and/or have been purchased less than a threshold number of times or purchased at less than a threshold purchase rate) and that have one or more product partiality vectors that have a threshold relationship with at least one of the customer's partiality vectors. The graphical representation of the one or more products can then be strategically displayed to draw the customer's attention to the one or more products. This can include displaying then in a position more likely to be viewed (e.g., based on customers' historic viewing patterns, the customer's purchases relative to previous access to the rendered retail environment and the placement of products, and the like), placed with an enhanced size, or other such display factors.

Some embodiments determine product prioritization information prioritizing multiple recommended products of a set of recommended products. The prioritization can, in some embodiments, be determined as a function of a level of correlation between the product partiality vectors of the multiple recommended products and a customer's set of partiality vectors. Product prioritization information can be communicated to cause at least the graphical representations of multiple recommended products of the set of recommended products to be displayed in an order at least based on the prioritization of the multiple recommended products. In some implementations, the rendered retail environment would display multiple products (e.g., as though a customer is looking along an isle at a brick and mortal retail store) that include one or more recommended products and one or more non-recommended products. Accordingly, the organization can further include organizing the recommended products and the non-recommended products. This organization can take into consideration the prioritization of the recommended products, and may further consider prioritization of non-recommended products.

In some embodiments, product preferences are identified that correspond to one or more of the multiple recommended products. The product preferences may be obtained from a customer profile from a customer profile database. Further, each of the product preferences typically corresponds to the customer's historic tendency of purchasing one or more products over one or more secondary similar products. Product prioritization information can be determined as a function of the product preferences and the level of correlation between the product partiality vectors of the multiple recommended products and the customer's set of partiality vectors. Some embodiments further customize products according to a customer's purchase history. Customization parameters (e.g., color, size, quantity, etc.) specific to a customer correlating to purchased products can be identified based on a customer's historic purchases. The graphical characteristics of one or more of the set of recommended products can be modified to be consistent with customization parameters and with available actual products (e.g., based on inventory at one or more shopping facilities, fulfillment centers, distribution centers, or the like). The recommendation content can be communicated to causes the graphical representations one or more of the set of recommended products to be displayed in accordance with the modified graphical characteristics.

Some embodiments determine a virtual location within the rendered retail environment with which the customer is currently interested. Each of the recommended products of the set of recommended products can be identified based on a relationship of the set of recommended products relative to the virtual location and based on the relationship between the products' partiality vectors and the first customer's partiality vectors. Product prioritization information prioritizing multiple recommended products of the set of recommended products and/or non-recommended products can be determined as a function of a level of correlation between the product partiality vectors of the multiple recommended products and a customer's set of partiality vectors. Retail environment organization data can further be determined that dictates an organization of the rendered retail environment based on the product prioritization information. The retail environment organization data can be communicated to cause the graphical representations of the first rendered retail environment to be displayed in accordance with the organization of the first rendered retail environment.

In some embodiments, systems, apparatus and corresponding methods, comprise: a retail service control circuit remotely accessible by customers over a distributed computer network and that provides access to computer-graphically rendered retail environments, wherein the control circuit accesses memory storing instructions that when executed by the control circuit cause the control circuit to: identify a first customer remotely accessing, through a customer computing system, a first rendered retail environment configured for the first customer; access a set of customer partiality vectors corresponding to the first customer, wherein customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order; identify a first set of recommended products each having at least a threshold relationship between corresponding product partiality vectors and one or more of the first customer's partiality vectors; and communicate, to the customer computing system, recommendation content that dictates an organization of displayed representations of products in the first rendered retail environment specific to the first customer and causes graphical representations of the first set of recommended products to be displayed within the first rendered retail environment. In some embodiments, the control circuit is configured to: identify, from product information for a first of the recommended products, a first product partiality vector that has the threshold relationship with at least one of the first customer's partiality vectors; and cause marketing information representative of the first product partiality vector to be displayed in association with the displayed graphical representation of the first recommended product.

In some embodiments, the control circuit in causing the marketing information to be displayed further causes the marketing information to be displayed as an emphasized characteristic of the first recommended products. In some applications, the control circuit is configured to: identify, based on a purchase history of the first customer, a first product that has not previously been purchased by the first customer and that has the first product partiality vector that has the threshold relationship with at least one of the first customer's partiality vectors; and wherein the control circuit in communicating the recommendation content causes a graphical representation of the first product to be strategically displayed to draw the first customer's attention to the first product. The control circuit, in some embodiments, is further configured to: determine product prioritization information prioritizing multiple recommended products of the first set of recommended products as a function of a level of correlation between the product partiality vectors of the multiple recommended products and the first customer's set of partiality vectors; and communicate product prioritization information and causing the graphical representations of multiple recommended products of the first set of recommended products to be displayed in an order at least based on the prioritization of the multiple recommended products. In some embodiments the control circuit is configured to: identify, from a customer profile database, product preferences corresponding to one or more of the multiple recommended products, wherein each of the product preferences corresponds to the first customer's historic tendency of purchasing a first product over one or more secondary similar products; and wherein the control circuit in determining the product prioritization information determines the product prioritization as a function of the product preferences and the level of correlation between the product partiality vectors of the multiple recommended products and the first customer's set of partiality vectors.

In some implementations, the control circuit is configured to: identify, based on customer's historic purchases, customization parameters specific to the first customer correlating to purchased products; modify the graphical characteristics of one or more of the first set of recommended products to be consistent with customization parameters and with available actual products; wherein the control circuit in communicating the recommendation content further causes the graphical representations of the one or more of the first set of recommended products to be displayed in accordance with the modified graphical characteristics. In some embodiments, the control circuit is configured to determine a virtual location within the first rendered retail environment with which the customer is currently interested, wherein control circuit in identifying the first set of recommended products identifies each of the recommended products of the first set of recommended products based on a relationship of the first set of recommended products relative to the virtual location and based on the relationship between the products' partiality vectors and the first customer's partiality vectors. The control circuit, in some embodiments, is configured to: determine product prioritization information prioritizing multiple recommended products of the first set of recommended products as a function of a level of correlation between the product partiality vectors of the multiple recommended products and the first customer's set of partiality vectors; determine retail environment organization data dictating an organization of the first rendered retail environment based on the product prioritization information; and communicate the retail environment organization data causing the graphical representations of the first rendered retail environment to be displayed in accordance with the organization of the first rendered retail environment.

Some embodiments comprise methods of providing a retail shopping environment, comprising: by a retail service control circuit: identifying a first customer remotely accessing, through a customer computing system, a first rendered retail environment configured for the first customer; accessing a set of customer partiality vectors corresponding to the first customer, wherein customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order; identifying a first set of recommended products each having at least a threshold relationship between corresponding product partiality vectors and one or more of the first customer's partiality vectors; and communicating, to the customer computing system, recommendation content that dictates an organization of displayed representations of products in the first rendered retail environment specific to the first customer and causes graphical representations of the first set of recommended products to be displayed within the first rendered retail environment. Some embodiments further comprise identifying, from product information for a first of the recommended products, a first product partiality vector that has the threshold relationship with at least one of the first customer's partiality vectors; and causing marketing information representative of the first product partiality vector to be displayed in association with the displayed graphical representation of the first recommended product. In some embodiments, the causing the marketing information to be displayed comprises causing the marketing information to be displayed as an emphasized characteristic of the first recommended products.

In some embodiments the method further comprises: identifying, based on a purchase history of the first customer, a first product that has not previously been purchased by the first customer and that has the first product partiality vector that has the threshold relationship with at least one of the first customer's partiality vectors; and causing a graphical representation of the first product to be strategically displayed to draw the first customer's attention to the first product. Some embodiments further comprise: determining product prioritization information prioritizing multiple recommended products of the first set of recommended products as a function of a level of correlation between the product partiality vectors of the multiple recommended products and the first customer's set of partiality vectors; and communicating product prioritization information and causing the graphical representations of multiple recommended products of the first set of recommended products to be displayed in an order at least based on the prioritization of the multiple recommended products. In some implementations, the method further comprises: identifying, from a customer profile database, product preferences corresponding to one or more of the multiple recommended products, wherein each of the product preferences corresponds to the first customer's historic tendency of purchasing a first product over one or more secondary similar products; and wherein the determining the product prioritization information comprises determining the product prioritization as a function of the product preferences and the level of correlation between the product partiality vectors of the multiple recommended products and the first customer's set of partiality vectors.

In some embodiments, the method further comprises: identifying, based on customer's historic purchases, customization parameters specific to the first customer correlating to purchased products; modifying the graphical characteristics of one or more of the first set of recommended products to be consistent with customization parameters and with available actual products; wherein the communicating the recommendation content further causes the graphical representations of the one or more of the first set of recommended products to be displayed in accordance with the modified graphical characteristics. Some embodiments further comprise: determining a virtual location within the first rendered retail environment with which the customer is currently interested; wherein the identifying the first set of recommended products comprises identifying each of the recommended products of the first set of recommended products based on a relationship of the first set of recommended products relative to the virtual location and based on the relationship between the products' partiality vectors and the first customer's partiality vectors. In some embodiments, the method further comprises: determining product prioritization information prioritizing multiple recommended products of the first set of recommended products as a function of a level of correlation between the product partiality vectors of the multiple recommended products and the first customer's set of partiality vectors; determining retail environment organization data dictating an organization of the first rendered retail environment based on the product prioritization information; and communicating the retail environment organization data causing the graphical representations of the first rendered retail environment to be displayed in accordance with the organization of the first rendered retail environment.

Some embodiments provide apparatuses, comprising: a memory having stored therein: information including partiality information for each of a plurality of persons in the form of a plurality of partiality vectors for each of the persons wherein the partiality vector has at least one of a magnitude and an angle that corresponds to a magnitude of the person's belief in an amount of good that comes from an order associated with that partiality; and vectorized characterizations for each of a plurality of products, wherein each of the vectorized characterizations indicates a measure regarding an extent to which a corresponding one of the products accords with a corresponding one of the plurality of partiality vectors. In some embodiments the apparatus further comprises: a control circuit operably coupled to the memory and configured to compare a particular one of the partiality vectors for a particular one of the plurality of persons to each of a plurality of the vectorized characterizations to thereby identify a particular one of the plurality of products that best accords with the particular one of the partiality vectors. The control circuit, in some implementations, is configured to compare the particular one of the partiality vectors to each of the plurality of the vectorized characterizations using vector dot product calculations. The partiality information, in at least some embodiments, include values, preferences, aspirations, and affinities. In some embodiments, the apparatus further comprises: a control circuit operably coupled to the memory and configured as a state engine that uses the partiality vectors and the vectorized characterizations to identify at least one product to present to a customer.

In some embodiments the apparatus further comprises: a control circuit operably coupled to the memory and configured to use the partiality vectors and the vectorized characterizations to identify at least one product to present to the customer by, at least in part: using the partiality vectors and the vectorized characterizations to define a plurality of solutions that collectively form a multi-dimensional surface; selecting the at least one product from the multi-dimensional surface. The control circuit, in some instances, is further configured to use the partiality vectors and the vectorized characterizations to identify at least one product to present to the customer by, at least in part: accessing other information for the customer comprising information other than partiality vectors; using the other information to constrain a selection area on the multi-dimensional surface from which the at least one product can be selected. In some embodiments, the other information comprises objective information.

This application is related to, and incorporates herein by reference in its entirety, each of the following U.S. provisional applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; and 62/485,045 filed Apr. 13, 2017.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A remote retail system, comprising:
a retail service control circuit remotely accessible by customers over a distributed computer network and that provides access to computer-graphically rendered retail environments, wherein the control circuit accesses memory storing instructions that when executed by the control circuit cause the control circuit to:
identify a first customer remotely accessing, through a customer computing system, a first rendered retail environment configured for the first customer;
access a set of customer partiality vectors corresponding to the first customer, wherein customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order;
identify a first set of recommended products each having at least a threshold relationship between corresponding product partiality vectors and one or more of the first customer's partiality vectors; and
communicate, to the customer computing system, recommendation content that dictates an organization of displayed representations of products in the first rendered retail environment specific to the first customer and causes graphical representations of the first set of recommended products to be displayed within the first rendered retail environment.

2. The system of claim 1, wherein the control circuit is configured to:
identify, from product information for a first of the recommended products, a first product partiality vector that has the threshold relationship with at least one of the first customer's partiality vectors; and
cause marketing information representative of the first product partiality vector to be displayed in association with the displayed graphical representation of the first recommended product.

3. The system of claim 2, wherein the control circuit in causing the marketing information to be displayed further causes the marketing information to be displayed as an emphasized characteristic of the first recommended products.

4. The system of claim 2, wherein the control circuit is configured to:
identify, based on a purchase history of the first customer, a first product that has not previously been purchased by the first customer and that has the first product partiality vector that has the threshold relationship with at least one of the first customer's partiality vectors; and
wherein the control circuit in communicating the recommendation content causes a graphical representation of the first product to be strategically displayed to draw the first customer's attention to the first product.

5. The system of claim 1, wherein the control circuit is further configured to:
determine product prioritization information prioritizing multiple recommended products of the first set of recommended products as a function of a level of correlation between the product partiality vectors of the multiple recommended products and the first customer's set of partiality vectors; and
communicate product prioritization information and causing the graphical representations of multiple recommended products of the first set of recommended products to be displayed in an order at least based on the prioritization of the multiple recommended products.

6. The system of claim 5, wherein the control circuit is configured to:
identify, from a customer profile database, product preferences corresponding to one or more of the multiple recommended products, wherein each of the product preferences corresponds to the first customer's historic tendency of purchasing a first product over one or more secondary similar products; and
wherein the control circuit in determining the product prioritization information determines the product prioritization as a function of the product preferences and the level of correlation between the product partiality vectors of the multiple recommended products and the first customer's set of partiality vectors.

7. The system of claim 1, wherein the control circuit is configured to:
identify, based on customer's historic purchases, customization parameters specific to the first customer correlating to purchased products;
modify the graphical characteristics of one or more of the first set of recommended products to be consistent with customization parameters and with available actual products;
wherein the control circuit in communicating the recommendation content further causes the graphical representations of the one or more of the first set of recommended products to be displayed in accordance with the modified graphical characteristics.

8. The system of claim 1, wherein the control circuit is configured to determine a virtual location within the first rendered retail environment with which the customer is currently interested, wherein control circuit in identifying the first set of recommended products identifies each of the recommended products of the first set of recommended products based on a relationship of the first set of recommended products relative to the virtual location and based on the relationship between the products' partiality vectors and the first customer's partiality vectors.

9. The system of claim 1, wherein the control circuit is configured to:
determine product prioritization information prioritizing multiple recommended products of the first set of recommended products as a function of a level of correlation between the product partiality vectors of the multiple recommended products and the first customer's set of partiality vectors; and
determine retail environment organization data dictating an organization of the first rendered retail environment based on the product prioritization information; and
communicate the retail environment organization data causing the graphical representations of the first rendered retail environment to be displayed in accordance with the organization of the first rendered retail environment.

10. A method of providing a retail shopping environment, comprising:
by a retail service control circuit:
identifying a first customer remotely accessing, through a customer computing system, a first rendered retail environment configured for the first customer;
accessing a set of customer partiality vectors corresponding to the first customer, wherein customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order;
identifying a first set of recommended products each having at least a threshold relationship between corresponding product partiality vectors and one or more of the first customer's partiality vectors; and
communicating, to the customer computing system, recommendation content that dictates an organization of displayed representations of products in the first rendered retail environment specific to the first customer and causes graphical representations of the first set of recommended products to be displayed within the first rendered retail environment.

11. The method of claim 10, further comprising:
identifying, from product information for a first of the recommended products, a first product partiality vector that has the threshold relationship with at least one of the first customer's partiality vectors; and
causing marketing information representative of the first product partiality vector to be displayed in association with the displayed graphical representation of the first recommended product.

12. The method of claim 11, wherein the causing the marketing information to be displayed comprises causing the marketing information to be displayed as an emphasized characteristic of the first recommended products.

13. The method of claim 11, further comprising:
identifying, based on a purchase history of the first customer, a first product that has not previously been purchased by the first customer and that has the first product partiality vector that has the threshold relationship with at least one of the first customer's partiality vectors; and
causing a graphical representation of the first product to be strategically displayed to draw the first customer's attention to the first product.

14. The method of claim 10, further comprising:
determining product prioritization information prioritizing multiple recommended products of the first set of recommended products as a function of a level of correlation between the product partiality vectors of the multiple recommended products and the first customer's set of partiality vectors; and
communicating product prioritization information and causing the graphical representations of multiple recommended products of the first set of recommended products to be displayed in an order at least based on the prioritization of the multiple recommended products.

15. The method of claim 14, further comprising:
identifying, from a customer profile database, product preferences corresponding to one or more of the multiple recommended products, wherein each of the product preferences corresponds to the first customer's historic tendency of purchasing a first product over one or more secondary similar products; and
wherein the determining the product prioritization information comprises determining the product prioritization as a function of the product preferences and the level of correlation between the product partiality vectors of the multiple recommended products and the first customer's set of partiality vectors.

16. The method of claim 10, further comprising:
identifying, based on customer's historic purchases, customization parameters specific to the first customer correlating to purchased products;
modifying the graphical characteristics of one or more of the first set of recommended products to be consistent with customization parameters and with available actual products;
wherein the communicating the recommendation content further causes the graphical representations of the one or more of the first set of recommended products to be displayed in accordance with the modified graphical characteristics.

17. The method of claim 10, further comprising:
determining a virtual location within the first rendered retail environment with which the customer is currently interested;
wherein the identifying the first set of recommended products comprises identifying each of the recommended products of the first set of recommended products based on a relationship of the first set of recommended products relative to the virtual location and based on the relationship between the products' partiality vectors and the first customer's partiality vectors.

18. The method of claim 10, further comprising:
determining product prioritization information prioritizing multiple recommended products of the first set of recommended products as a function of a level of correlation between the product partiality vectors of the multiple recommended products and the first customer's set of partiality vectors;
determining retail environment organization data dictating an organization of the first rendered retail environment based on the product prioritization information; and
communicating the retail environment organization data causing the graphical representations of the first rendered retail environment to be displayed in accordance with the organization of the first rendered retail environment.
